(19) United States
(12) Patent Application Publication
(10) Pub. No.: US 2010/0302967 A1
(43) Pub. Date: Dec. 2, 2010

(54) METHOD AND APPARATUS FOR MEASURING NETWORK DELAY IN ETHERNET RING NETWORK

(75) Inventors: Sang-Min LEE, Daejeon (KR); Jeong-dong RYOO, Daejeon (KR); Daeub KIM, Daejeon (KR); Jea Hoon YU, Daejeon (KR); Tae Whan YOO, Daejeon (KR)

Correspondence Address: LADAS & PARRY LLP, 224 SOUTH MICHIGAN AVENUE, SUITE 1600, CHICAGO, IL, 60604, US

(73) Assignee: Electronics and Telecommunications Research Institute, Daejeon (KR)

(21) Appl. No.: 12/789,850

(22) Filed: May 28, 2010

(30) Foreign Application Priority Data
May 29, 2009 (KR) 10-2009-0047372
May 19, 2010 (KR) 10-2010-0047091

(51) Int. Cl. H04L 12/26

(52) U.S. Cl. 370/252

(57) ABSTRACT

A node generates a delay measurement frame and transmits it to an adjacent node of an Ethernet ring network in order to measure a delay of the network. The node receives the delay measurement frame generated by the node from another adjacent node of the ring network, and measures a network delay by using the received delay measurement frame.

### CROSS-REFERENCE TO RELATED APPLICATION

This application claims priority to and the benefit of Korean Patent Application Nos. 10-2009-0047372 and 10-2010-0047091 filed in the Korean Intellectual Property Office on May 29, 2009 and May 19, 2010, the entire contents of which are incorporated herein by reference.

### BACKGROUND OF THE INVENTION

(a) Field of the Invention

The present invention relates to a method for measuring a network delay in an Ethernet ring network.

(b) Description of the Related Art

A network delay represents a time when a frame leaves a departure node and arrives at a destination node of a network, and a delay occurs when the frame passes through a physical path of the network connecting the two nodes.

An Ethernet ring network forms a ring by connecting ports of respective nodes to ports of adjacent nodes, and prevents the formation of loops by blocking a predetermined port. In this instance, since the blocked port is actually connected but logically blocked, it can immediately forward traffic when the logical blocking state is canceled. A ring protection link (RPL) is blocked for traffic channel under normal condition, i.e., the idle state, and a RPL owner node is an Ethernet Ring Node adjacent to the RPL that is responsible for blocking its end of the RPL under normal conditions. Furthermore, it is responsible for activating reversion behaviour from protection switching conditions. When network topology is changed by a reason such as occurrence of signal fail in the network, the node performs a protection switching process, and particularly, the RPL owner node makes the blocked port unblock. The protection switching mechanism is performed when the node at which signal fail occurred transmits a ring-automatic protection switching (R-APS) frame to adjacent nodes and all the nodes in the ring network receive the frame. Therefore, the network delay of Ethernet ring network can be regarded as the time during which the R-APS frame is forwarded to the all nodes of the ring network, and it is required to measure the accurate network delay since it may be a reference for determining whether protection switching is performed within the time for QoS.

One method for measuring the delay of the ring network uses a round trip delay. That is, the method measures the delay of the ring network by inserting a time stamp into a delay measurement frame and calculating a round trip time between two nodes. However, the round trip delay is an indirect measuring method, and frame processing performance of the two nodes should be considered during the round trip for measuring network delay. Also, since the network delay time is calculated by halving the round trip delay time, it may be assumed that the delays undergone by the frame on the round trip path are the same. Accordingly, it is impossible to accurately measure the network delay and it is not easy to measure the same by using the round trip delay.

The above information disclosed in this Background section is only for enhancement of understanding of the background of the invention and therefore it may contain information that does not form the prior art that is already known in this country to a person of ordinary skill in the art.

### SUMMARY OF THE INVENTION

Embodiments of the present invention provide a delay measuring method and apparatus having advantages of conveniently and accurately measuring a network delay in an Ethernet ring network.

An exemplary embodiment of the present invention provides a method for measuring a delay of an Ethernet ring network at a node of the Ethernet ring network including: generating a delay measurement frame; transmitting the delay measurement frame to an adjacent node of the ring network; receiving the delay measurement frame generated by the node from another adjacent node of the ring network; and measuring a network delay by using the received delay measurement frame.

The node may own a logically blocked port, and the node measures the network delay in the idle state.

The transmitting may include transmitting the delay measurement frame to the adjacent node through a port that is not block, and the receiving includes receiving the delay measurement frame through the logically blocked port.

The method may further include inserting a time stamp for indicating transmission time information into the delay measurement frame, and the measuring of a network delay includes calculating a difference between a transmission time and a delay measuring time of the frame by using the time stamp.

The delay measurement frame may include a delay measurement indicator for indicating a frame for measuring a delay and an identifier of the node having generated the delay measurement frame.

The delay measurement frame may be a ring automatic protection switching frame, and the delay measurement indicator corresponds to a predetermined value of a request/state field of the delay measurement frame.

The delay measurement frame may be an Ethernet operation, administration and maintenance (OAM) frame, and the generating includes generating the delay measurement frame by setting a predetermined value of an OpCode field of the Ethernet operation administration and maintenance frame.

The receiving may include receiving a frame from a first adjacent node and determining whether the received frame is a delay measurement frame generated by the node.

The determining may include forwarding the received frame to a second adjacent node unless the node receives the frame through the logically blocked port; and delivering the received frame to a delay measurer of the node, wherein the delay measurer determines whether the received frame is a delay measurement frame generated by the node.

The delivering the received frame may further include discarding the delivered frame when the delivered frame is not a delay measurement frame generated by the node.

The determining may include determining the received frame as a frame generated by the node when the node identifier included in the received frame corresponds to the identifier of the node.

The determining may include determining the received frame to be the delay measurement frame when a delay measurement indicator is indicated in the received frame.

The delay measurement frame may include a time stamp for indicating transmission time information, and the measuring of a network delay includes calculating a difference between a transmission time of the frame and a delay measurement time by using the time stamp.

Another embodiment of the present invention provides an apparatus for measuring a delay of an Ethernet ring network at a node of the network including: a delay measurement frame generator for generating a delay measurement frame; a transmitter for transmitting the delay measurement frame to an adjacent node of the ring network; a receiver for receiving the delay measurement frame generated by the node from another adjacent node of the ring network; and a measurer for measuring a network delay by using the received delay measurement frame.

The transmitter may insert a time stamp for indicating transmission time information into the delay measurement frame, and the measurer measures the network delay by using a time stamp inserted into the received delay measurement frame.

The measurer may not measure the network delay when the received delay measurement frame is not a delay measurement frame generated by the node.

According to an exemplary embodiment of the present invention, it is required to consider frame processing performance of one node since the node having generated and transmitted a delay measurement frame measures the delay of the Ethernet ring network, and it is possible to easily and accurately measure the delay since it is possible to measure the delay generated when the frame passes through the node of the ring network other than estimation from the round trip time.

### BRIEF DESCRIPTION OF THE DRAWINGS

FIG. 1 shows an Ethernet ring network according to an exemplary embodiment of the present invention.

FIG. 2 shows a block diagram of a network delay measuring apparatus of a node of an exemplary embodiment of the present invention.

FIG. 3 shows a flowchart of a method for receiving a delay measurement frame and measuring a delay according to an exemplary embodiment of the present invention.

FIG. 4 to FIG. 6 show a configuration of a delay measurement frame according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising”, will be understood to imply the inclusion of stated elements but not the exclusion of any other elements.

A delay measuring method of an Ethernet ring network according to an exemplary embodiment of the present invention will now be described in detail.

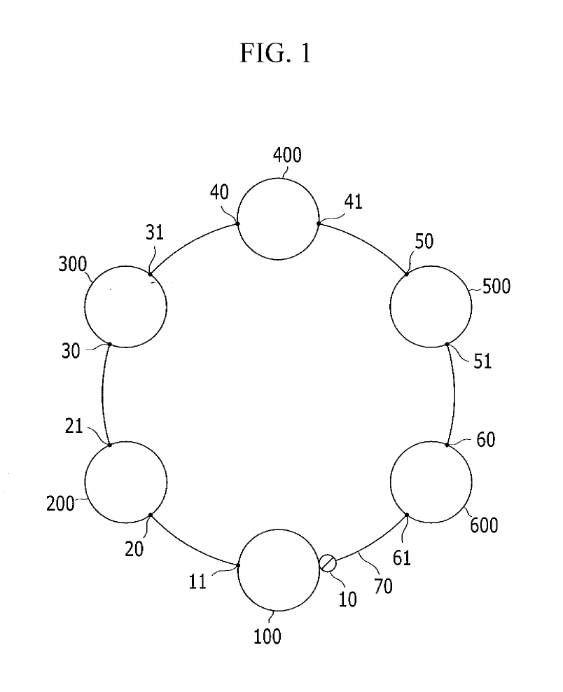

FIG. 1 shows an Ethernet ring network according to an exemplary embodiment of the present invention.

Referring to FIG. 1, the Ethernet ring network includes a plurality of nodes connected as a ring, for example, 6 nodes 100 to 600. The nodes 100 to 600 respectively include two ports 10, 11, 20, 21, 30, 31, 40, 41, 50, 51, 60 and 61 for connecting the ring network, and the ports 11, 21, 31, 41, 51 and 61 of the nodes 100 to 600 are connected to the ports 20, 30, 40, 50, 60 and 10 of the nodes that are adjacent in one direction, for example, the clockwise direction to thereby form a ring. In this instance, a link 70 for connecting the port 10 of the node 100 and the port 61 of the node 600 can be set to be an RPL that is logically blocked.

In the idle state, i.e., without any failure or request, the node 100 prevents the formation of a loop by blocking the port connected to the RPL, for example, the port 10. Since the port 10 is blocked, the node 100 cannot receive a data frame through the port 10. However, since the port 10 is not physically blocked by a signal fail but logically blocked, the node 100 can selectively receive the frame through the port 10. For example, the node 100 can receive a R-APS frame or an operation, administration and maintenance (OAM) frame through the blocked port 10. And the node 100 does not forward the frame that is received through the blocked port 10 to adjacent nodes.

The delay of the ring network may be the time during which the node 100 transmits a delay measurement frame in one direction (e.g., clockwise direction) and receives the frame forwarded through the nodes 200 to 600 of the ring network. The R-APS frame or the OAM frame can be used as a delay measurement frame for the Ethernet ring network to measure the delay according to an exemplary embodiment of the present invention. The node 100 can receive, through the blocked port 10, the R-APS frame or the OAM frame that is forwarded by the node 600 through the port 61. However, the node 100 does not forward the frame that is received through the blocked port 10 to adjacent nodes for preventing a loop. Therefore, though the nodes 200 to 600 transmit the delay measurement frame, the node 100 does not forward the receiving frame through the port 10. Hence, the nodes 200 to 600 cannot receive the delay measurement frame generated by the nodes 200 to 600. Accordingly, the RPL owner node 100 may measure the delay of the Ethernet ring network.

When a signal fail occurs in the network, the blocked port is changed into the failed port. The failed port cannot pass any frame. Therefore, the node 100 cannot receive the delay measurement frame transmitted by node 100 because of the failed port. Accordingly, the node 100 may measures the delay of the Ethernet ring network in the idle state, i.e. without any failure or request.

The node 100 may generate a delay measurement frame for measuring the delay in the idle state and may transmit the same to the adjacent nodes. In this instance, the node 100 set the delay measurement frame to be transmitted in one direction, for example, to the port 11. Also, since the delay can be measured with one frame, an unnecessary increase of frames in the network can be prevented by setting the delay measurement frame to be transmitted once instead of periodically transmitting the delay measurement frame.

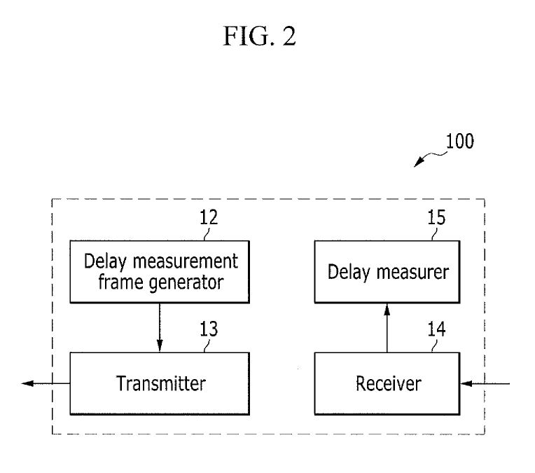

FIG. 2 shows a block diagram of a network delay measuring apparatus of a node of an exemplary embodiment of the present invention.

Referring to FIG. 2, the network delay measuring apparatus includes a delay measurement frame generator 12, a frame transmitter 13, a frame receiver 14, and a delay measurer 15.

The delay measurement frame generator 12 generates a delay measurement frame. The delay measurement frame may include a delay measurement indicator for indicating that the corresponding frame is the delay measurement frame. When the delay measurement frame is a R-APS frame, the delay measurement indicator may be inserted into a request/state field of the R-APS frame. When the delay measurement frame is an OAM frame, a specific field value, for example, an OpCode field value in the frame structure may be set with a predetermined value and it may be used as a delay measurement indicator. Further, the delay measurement frame may further include a node identifier for identifying the node that has generated the corresponding frame. For example, a MAC address of the node may be used as a node identifier.

The transmitter 13 transmits the generated delay measurement frame to the adjacent node 200 of the ring network. In this instance, the transmitter 13 inserts a time stamp including transmission time information into the delay measurement frame, and transmits the same to the adjacent node 200. he time stamp is used as a reference value for calculating the delay time.

The receiver 14 receives, through the different port from transmitting port, the delay measurement frame having passed through the other nodes 200 to 600 of the ring network. The receiver 14 may determine whether the received frame is a delay measurement frame by using the delay measurement indicator. The receiver 14 delivers the received frame to the delay measurer 15.

The delay measurer 15 receives the delay measurement frame from the receiver 14, and measures the network delay by using the time stamp included in the delay measurement frame. The delay measurer 15 calculates a difference between a transmission time and a delay measuring time by using the time stamp and set the difference as the network delay. The delay measurer 15 may correct a network delay time by applying the frame processing performance of the node 100, that is, the time used when the node 100 generates, transmits, receives, or measures the delay measurement frame.

When the frame used to measure the network delay is not the delay measurement frame generated by the node 100, the calculated delay time is not the wanted network delay time since it has passed through part of the node of the ring network. Therefore, the delay measurer 15 determines whether the frame is generated by the node 100 by checking a node identifier included in the frame, and calculates the network delay time when it is generated by the node.

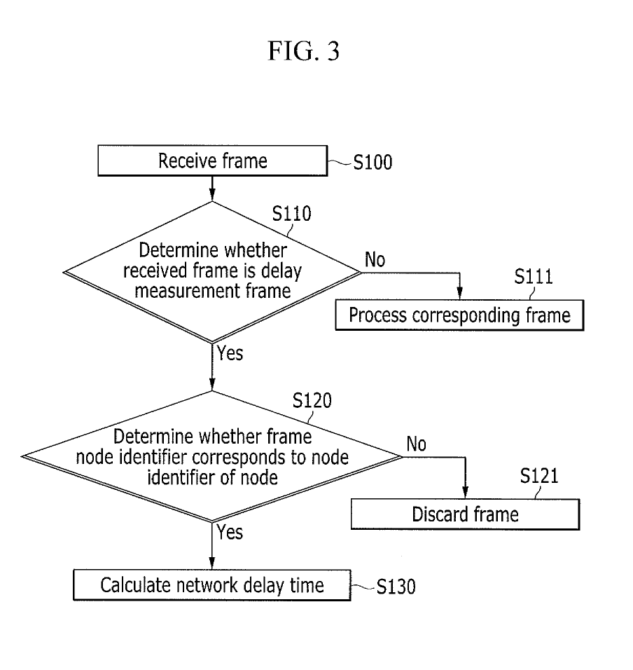

FIG. 3 shows a flowchart of a method for measuring a delay when a node according to an exemplary embodiment of the present invention receives a delay measurement frame.

Referring to FIG. 1 and FIG. 3, the node 100 receives a frame (S100), and determines whether the received frame is a delay measurement frame (S110) by using a delay measurement indicator. When the frame is not a delay measurement frame, the node 100 performs an operation corresponding to the frame (S111).

When the frame is a delay measurement frame, the node 100 determines whether the node having generated the frame corresponds to the node 100 (S120). The node 100 may determine whether the received frame is generated by the node 100 by using the node identifier. It is not the wanted delay of the ring network if it is measured between a certain amount of nodes forming the ring network, so it is needed to determine whether the frame is generated by the node.

When the received frame is the delay measurement frame generated by the node, the node 100 calculates the network delay time (S130). The network delay time can be set to be a difference between a transmission time of the delay measurement frame and a delay measuring time by using the time stamp included in the frame.

When the node 100 has generated and transmitted the delay measurement frame, the nodes 200 to 600 does not calculate the network delay time since the received frame is not generated by the nodes 200 to 600. In this case, the nodes 200 to 600 can discard the received frame (S121).

The frame is forwarded through the nodes 200 to 600 so that the node 100 receives the frame and measure the delay. For this purpose, the nodes 200 to 600 forward the received frame to an adjacent node through the different port from the receiving port. In this instance, the nodes 200 to 600 deliver the received frame to delay measurer, for example, ERP (Ethernet Ring Protection) control processor of each node. The nodes 200 to 600 determines whether the corresponding frame is the delay measurement frame generated by the nodes 200 to 600 by using the delivered frame, and may discard the delivered frame when it is not generated by the nodes 200 to 600. The node 100 also determines whether it is the delay measurement frame generated by the node 100 by using the frame delivered to the delay measurer, and does not forward the frame to the adjacent node for preventing a loop if the node receives the frame through the logically blocked port.

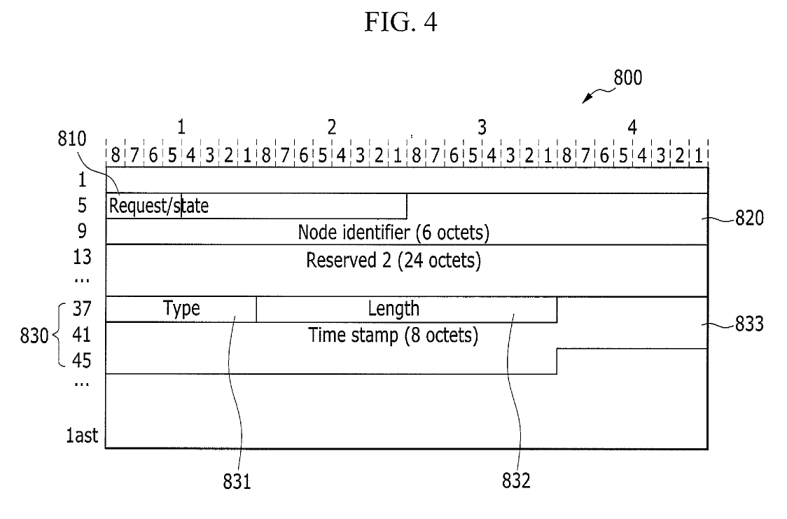

FIG. 4 to FIG. 6 show a configuration of a delay measurement frame according to an exemplary embodiment of the present invention.

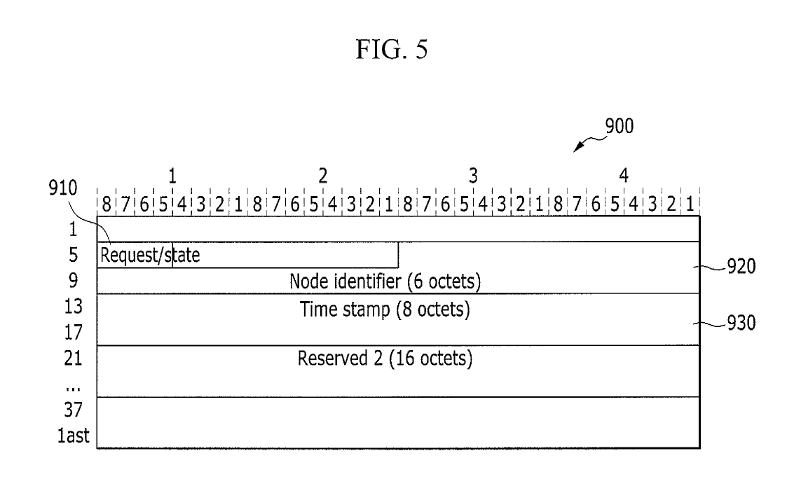

Referring to FIG. 4 and FIG. 5, R-APS frames 800 and 900 can be used as delay measurement frames according to an exemplary embodiment of the present invention.

The R-APS frames 800 and 900 include delay measurement indicators 810 and 910. The delay measurement indicator can be inserted into a request/state field of the frame. That is, the delay measurement indicator displays that the corresponding frame is a delay measurement frame by setting a value of the request/state field to be a predetermined value.

The R-APS frames 800 and 900 can further include time stamps 830 and 930 for indicating transmission time information. As shown in FIG. 4, the time stamp can be inserted into an optional type, length, value (TLV) field 830 of the R-APS frame. For this aim, for example, a first octet of the optional TLV field 830 is set to be a type field 831 for indicating that a time stamp is inserted, a second octet and a third octet of the optional TVL field 830 are set to be a length field 832 for indicating a length of the time stamp, and fourth to eleventh octets are used for a time stamp 833. Differing from this, as shown in FIG. 5, a predetermined part of the reserved 2 field of the R-APS frame, for example, the first to eighth octets can be used for a time stamp 930.

The R-APS frames 800 and 900 may further include identifiers 820 and 920 of the node having generated the frame.

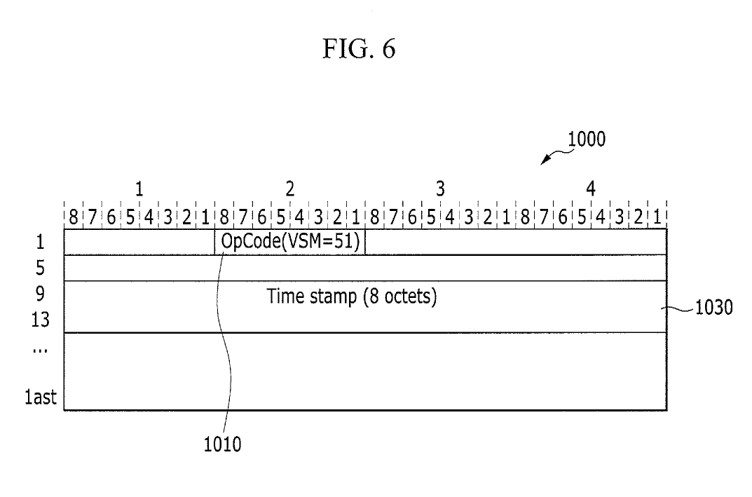

Referring to FIG. 6, an OAM frame 1000 can be used for a delay measurement frame according to another exemplary embodiment of the present invention. Particularly, the vendor specific OAM message (VSM) frame in the OAM frame can be used for the delay measurement frame. To achieve this purpose, a value of the OpCode field 1010 can be set as 51 to use the VSM frame in the OAM frame. The OAM frame 1000 includes a time stamp 1030 for displaying transmission time information to a predetermined field of the VSM frame.

Accordingly, according to the exemplary embodiment of the present invention, the node having generated the delay measurement frame receives the same again to measure a delay, and hence, a frame processing delay at another node need not be considered. Also, accurate delay time can be calculated compared to the time estimated by the round trip delay.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for measuring a delay of an Ethernet ring network at a node of the Ethernet ring network, the method comprising:
generating a delay measurement frame;
transmitting the delay measurement frame to an adjacent node of the ring network;
receiving the delay measurement frame generated by the node from another adjacent node of the ring network; and
measuring a network delay by using the received delay measurement frame.

2. The method of claim 1, wherein the node owns a logically blocked port.

3. The method of claim 2, wherein the node measures the network delay in the idle state.

4. The method of claim 2, wherein the transmitting comprises transmitting the delay measurement frame to the adjacent node through a port that is not blocked, and
the receiving comprises receiving the delay measurement frame through the logically blocked port.

5. The method of claim 1, further comprising
inserting a time stamp for indicating transmission time information into the delay measurement frame.

6. The method of claim 5, wherein
the measuring of a network delay comprises
calculating a difference between a transmission time and a delay measuring time of the frame by using the time stamp.

7. The method of claim 1, wherein
the delay measurement frame comprises a delay measurement indicator for indicating a frame for measuring a delay and an identifier of the node having generated the delay measurement frame.

8. The method of claim 7, wherein
the delay measurement frame is a ring automatic protection switching frame.

9. The method of claim 8, wherein
the delay measurement indicator corresponds to a predetermined value of a request/state field of the delay measurement frame.

10. The method of claim 1, wherein
the delay measurement frame is an Ethernet operation administration and maintenance (OAM) frame.

11. The method of claim 10, wherein
the generating comprises
generating the delay measurement frame by setting a predetermined value of an OpCode field of the Ethernet operation administration and maintenance frame.

12. The method of claim 1, wherein
the receiving comprises
receiving a frame from a first adjacent node; and
determining whether the received frame is a delay measurement frame generated by the node.

13. The method of claim 12, wherein
the determining comprises:
forwarding the received frame to a second adjacent node unless the node receives the frame through the logically blocked port; and
delivering the received frame to a delay measurer of the node,
wherein the delay measurer determines whether the received frame is a delay measurement frame generated by the node

14. The method of claim 13, wherein
the delivering the received frame further comprises
discarding the delivered frame when the delivered frame is not a delay measurement frame generated by the node.

15. The method of claim 12, wherein
the determining comprises
determining the received frame as a frame generated by the node when the node identifier included in the received frame corresponds to the identifier of the node.

16. The method of claim 12, wherein
the determining comprises
determining the received frame to be the delay measurement frame when a delay measurement indicator is indicated in the received frame.

17. An apparatus for measuring a delay of an Ethernet ring network at a node of the network, the apparatus comprising:
a delay measurement frame generator for generating a delay measurement frame;
a transmitter for transmitting the delay measurement frame to an adjacent node of the ring network;
a receiver for receiving the delay measurement frame generated by the node from another adjacent node of the ring network; and
a measurer for measuring a network delay by using the received delay measurement frame.

18. The apparatus of claim 17, wherein
the transmitter inserts a time stamp for indicating transmission time information into the delay measurement frame, and
the measurer measures the network delay by using a time stamp inserted into the received delay measurement frame.

19. The apparatus of claim 17, wherein
the measurer does not measure the network delay when the received delay measurement frame is not a delay measurement frame generated by the node.
